(19) United States
(12) Patent Application Publication
(10) Pub. No.: US 2007/0196681 A1
(43) Pub. Date: Aug. 23, 2007

(54) Laminate panel and process for production thereof

(76) Inventors: Taryn Biggs, Burlington (CA); Frank Castriciano, Brescia (IT); Karen Choonoo, Petersburg (CA); Gina Guerra, Hamilton (CA); Kevin Hayes, Stoney Creek (CA); Jeffrey Witt, Waterdown (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 11/273,627

(22) Filed: Nov. 15, 2005

Related U.S. Application Data
(60) Provisional application No. 60/627,148, filed on Nov. 15, 2004.

(51) Int. Cl. B32B 15/14; C09J 5/06; B22F 3/10

(52) U.S. Cl. 428/550; 442/378; 442/232; 156/321

(57) ABSTRACT

There is disclosed a laminate panel and a process for production thereof. The laminate panel comprises a core layer disposed between and bonded to each of a first metal layer and a second metal layer. The core layer comprises a porous layer substantially encapsulated by a thermoplastic resin. An advantage of the present laminate material is that it can withstand paint/bake cycles while maintaining a desirable balance of physical properties (e.g., peel strength, stiffness, impact resistance and the like). Another distinct advantage of the present laminate panel is its formability. This allows for the use medium or deep draw forming techniques to facilitate production of parts having a variety of shapes and radii (e.g., 90° bends, draws, stretches, multi-shape configurations and the like) for vehicular applications.

### CROSS-REFERENCE TO RELATED APPLICATION

The present application claims the benefit under 35 U.S.C. §119(e) of provisional patent application Ser. No. 60/627,148, filed Nov. 15, 2004, the contents of which are hereby incorporated by reference.

### BACKGROUND OF THE INVENTION

1. Field of the Invention

In one of its aspects, the present invention relates to a laminate panel, more particularly to a metal skinned laminate panel. In yet another of its aspects, the present invention relates to a method for producing a laminate panel.

2. Description of the Prior Art

Sheet steel is used extensively to form panels. The required structural characteristics, such as stiffness, vary depending upon the specific application. When higher stiffness values are required, the steel thickness is typically increased. Increasing sheet steel thickness, however, produces a panel that is not only heavier, but also more expensive.

A number of approaches have been taken in the past to provide improved acoustical characteristics of panels. For example, composites of steel sheets having a solid polymer core have been used in applications where sound deadening and vibration dampers are required. The weight and cost of laminate products incorporating such polymer core materials, however, is less than desirable.

In recent years, attention has been directed to the use of other core materials in metal skinned structural panels.

U.S. Pat. No. 5,985,457 [David D'Arcy Clifford (Clifford #1)] teaches a structural panel which comprises a metal and paper composite in which the metal outer skins have a minimum thickness of 0.005 in. exceeding foils and a maximum thickness of 0.012 in. while the paper core ranges between 0.01 in. and 0.05 in. The panel is a stiff, lightweight substitute for thicker metals and may replace light metal sheets such as aluminum with a composite in which the metal skins comprise sheets from heavier metals such as steel. The paper core is a web which is adhesively bonded to the metal skins and which may have openings to create paths for adhesive bridges between the metal skins to minimize failure caused by buckling.

U.S. Pat. No. 6,171,705 [David D'Arcy Clifford (Clifford #2)] teaches a structural laminate having first and second skins of sheet metal. Each of the sheet metal skins has a thickness of at least about 0.005 inches. A fibrous core layer is provided between the sheet metal skins and is bonded to the skins. In one aspect, the fibrous core layer is impregnated with an adhesive resin which bonds the core layer directly to the skins. In another aspect, layers of adhesive are placed between the core material and the metal skins that bond the core to the skins. While a passing reference is made to the use of a thermoplastic resin as the adhesive, Clifford #2 emphasizes the use of a thermoset resin. The resulting laminate structure is extremely lightweight compared to a single steel sheet of comparable thickness and strength.

While the teachings of Clifford #1 and Clifford #2 represent significant advances in the art, there is still room for improvement.

Specifically, a particular application of interest in laminate materials such as those described in Clifford #1 and Clifford #2 is in vehicular applications such as door panels, roof tops, hoods, floor panels, Tonneau covers, cargo panels, exterior panels, interior panels and the like.

For such a laminate material to be useful in vehicular applications, it is highly desirable that it withstand the so-called “paint/bake” cycles to which exterior vehicular parts and panels are subjected during manufacture/assemble of the vehicle. Specifically, it is conventional to subject the particular panel to a number of successive painting and baking cycles to build up a high quality finish on the panel.

The temperatures of the baking cycle can exceed 150° C. (typically, the temperature is approximately 180° C.). When the panel is made of steel alone, this is not a problem. However, if a composite material, such as that described in Clifford #1 and Clifford #2 is used, there is a risk that the resin used in the laminate may have a softening point near or a melting point below the baking temperature referred to above. On the other hand, whatever materials are used in the laminate, it is important that the successive paint/bake cycles to which the panel is subjected not have a deleterious effect on the physical properties (e.g., peel strength, stiffness, impact resistance and the like) of the resulting laminate panel.

Thus, it would be desirable to have a laminate material having the physical property advantages set out in Clifford #1 and Clifford #2 while avoiding the problems associate it with the paint/bake cycle referred to above. It would be particularly advantageous if such a laminate material possessed a desirable combination of physical properties rendering it suitable for use in vehicular applications.

### SUMMARY OF THE INVENTION

It is an object of the present invention to obviate or mitigate at least one of the above-mentioned disadvantages of the prior art.

It is another object of the present invention to provide a laminate panel capable of withstanding the conditions of paint/bake cycles to which vehicular panels are conventionally subjected.

It is another object of the present invention to provide a laminate panel having desirable properties (e.g., impact load or impact resistance) for use in a vehicular application.

It is another objection of the present invention to provide a novel process for producing a laminate panel.

According, in one of its aspects, the present invention provides a laminate panel comprising:

a core layer disposed between and bonded to each of a first metal layer and a second metal layer,

the core layer comprising a porous layer substantially encapsulated by a thermoplastic resin.

In another of its aspects, the present invention provides a process for producing a laminate panel comprising the steps of:

disposing a core layer between a first metal layer and a second metal layer to define an interim laminate, the core layer comprising a first adhesive layer on a surface of a porous layer, the first adhesive layer comprising a thermoplastic material; and

subjecting the interim laminate to a compression step at a temperature of at least about 150° C. and pressure sufficient to cause the first adhesive layer to substantially encapsulated the porous layer, to produce the laminate panel.

Thus, the present inventors have discovered a laminate material consisting of a novel combination of a porous layer and thermoplastic resin that can withstand the paint/bake cycles referred to above while maintaining a desirable balance of physical properties (e.g., peel strength, stiffness, impact resistance and the like). Another distinct advantage of the present laminate panel is its formability. This allows for the use medium or deep draw forming techniques to facilitate production of parts having a variety of shapes and radii (e.g., 90° bends, draws, stretches, multi-shape configurations and the like) for vehicular applications.

### BRIEF DESCRIPTION OF THE DRAWINGS

Embodiments of the present invention will be described with reference to the accompanying drawings, wherein like reference numerals denote like parts, and in which:

FIG. 1 illustrates a sectional view an embodiment of the present laminate panel;

FIG. 2 illustrates a perspective view, and partial section of the laminate panel illustrated in FIG. 1;

FIG. 3 illustrates a sectional view of a second embodiment of the present laminate panel;

FIG. 4 illustrates a top plan view of a preferred embodiment of a porous layer useful in the core layer of the present laminate; and

FIG. 5 is a graphical illustration of the results of samples made in the Examples reported below.

### DETAILED DESCRIPTION OF THE PREFERRED EMBODIMENTS

The core layer of the present laminate panel comprises at least one porous layer that is substantially encapsulated by a thermoplastic resin.

As used throughout this specification, the term “porosity” and “porous”, for example when used in conjunction with the core layer of the present laminate panel, is intended to encompass a material having a sufficient number of pores or openings through which a liquid may pass with little or no resistance when the liquid is poured on to the material.

In one preferred embodiment, the porous layer may be fibrous. A particularly preferred example of such a porous layer may be selected by the group comprising burlap, hemp, jute and the like.

Alternatively, the porous layer may be made of non-fiber material. For example, the porous layer may be made of wire and non-metal material such as plastic and the like.

The porous layer may be woven or non-woven.

It is preferred that the porous layer have sufficient porosity such that it may be readily substantially completely encapsulated by thermoplastic resin or material.

Preferably, the porous layer is made up of a network or grid-like arrangement of metal or non-metal material to define a series of openings.

In such an arrangement, the porosity of the porous layer may be defined as the percentage of aggregate pore surface area of a planar surface of the porous layer as a function of the total surface area of the porous layer (in other words, “porosity” can be viewed as the degree of openness in a network, grid-like or similar arrangement in the porous layer). For example, porous layer comprises a porosity of 10%, a 1 ft² flat sample of the porous layer contains 0.1 ft² with the balance (i.e., 0.9 ft²) being consisting of fiber material. It should be appreciated that reference to a flat sample for specification of porosity is simply to assess that property of the porous layer and not to otherwise restricted the shape a laminate comprising such a porous layer.

Thus, it is preferred that the porous layer comprise a porosity of at least about 10%, more preferably in the range of from about 10% to about 90%, more preferably in the range from about 20% to about 80%, more preferably in the range from about 30% to about 70%, most preferably in the range from about 35% to about 65%.

From a processing viewpoint, the porous layer should have a porosity sufficient to allow encapsulation thereof by the thermoplastic resin at temperatures and pressures typically used in the production of laminates such as those described in Clifford #1 and Clifford #2. Practically, this excludes Kraft paper (the preferred material in Clifford #1 and Clifford #2) as being suitable for use as the only porous layer in the present laminate panel.

It is also preferred that the porous layer can be a sheet-like material. In some cases one or more of such sheets may be used in the core layer, although it is preferred to use only a single such sheet. Alternatively, it is possible that the porous layer could be thicker then a typical sheet-like material—e.g., a reticulated foam layer and the like.

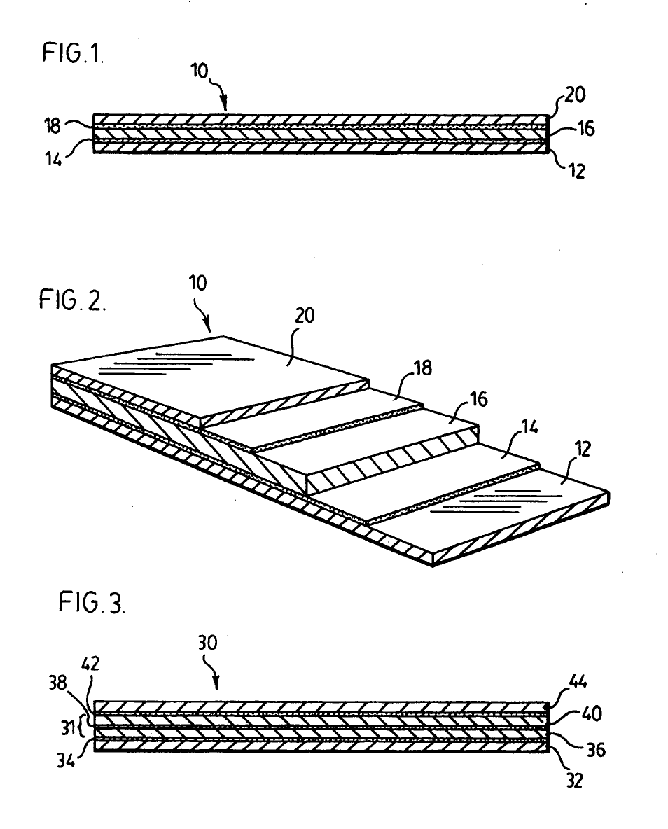

With reference to FIG. 1, there is illustrated a interim laminate panel 10. Interim laminate panel 10 includes a first metal skin layer 12 and a second metal skin layer 20. Interposed between first metal skin layer 12 and second metal skin layer 20 is a porous layer 16.

A first adhesive layer 14 is disposed between first metal skin layer 12 and porous layer 16. A second adhesive layer 18 (optional) is disposed between porous layer and second metal skin layer 20. First adhesive layer 14 and second adhesive layer 18 (if present) each comprise a thermoplastic resin.

Laminate panel 10 is referred to as interim since, during the present process, the thermoplastic resin the in the adhesive layer(s) substantially encapsulates porous layer 16.

Further, first adhesive layer 14 serves to bond first metal skin layer 12 to porous layer 16. If second adhesive layer 18 is used, it serves to bond porous layer 16 to second metal skin layer 20. If second adhesive layer 18 is not used, first adhesive layer 14 substantially encapsulates porous layer 16 and also serves to bond porous layer 16 to second metal skin layer 20.

With reference to FIG. 3, there is illustrated an interim laminate panel 30. Interim laminate panel 30 comprises a first metal skin layer 32 and a second metal skin layer 44. Disposed between first metal skin layer 32 and second metal skin layer 44 is a core 31. Core layer 31 comprises a pair of porous layers 36 and 40 having interposed therebetween an adhesive layer 38.

Laminate panel 30 is referred to as interim since, during the present process, the thermoplastic resins in each of adhesive layers 34,38,42 co-mingle to substantially encapsulates porous layer 16 and to bond core 31 to first metal skin layer 32 and to second metal skin layer 44.

Those of skill in the art will understand that core 31 may be modified to have more porous layers and adhesive layers such that core layer 31 itself is a laminate.

Thus, while not shown for purposes of clarity in FIGS. 1-3, the adhesive layer substantially completely encompasses the adjacent porous layer. If a plurality of porous layers are used, it is preferred that thermoplastic resin (e.g., from one or both of the first adhesive layer and the second adhesive layer) substantially completely encompasses the adjacent porous layer.

The first adhesive layer and the second adhesive layer (if present) comprise a thermoplastic resin. The thermoplastic resin may be the same or different in the first adhesive layer and the second adhesive layer. In one preferred embodiment of the present laminate panel, the thermoplastic adhesive layer comprises polyethylene or thermoplastic elastomer such as a copolyester elastomer (e.g., ether polyester elastomer or ester polyester elastomer). A particularly preferred embodiment of copolyester elastomer useful in the first adhesive layer and/or the second adhesive layer of the present laminate panel is commercially available under the trade name Arnitel™.

The particular choice for metal skin layers used in the present laminate panel is not particularly restricted and again, more details on this can be see from Clifford #1 and Clifford #2 described above.

Thus, the first metal layer and the second metal layer may be the same or different. Non-limiting examples of suitable metal layers for use in the present laminate include aluminum, cold rolled steel, galvanized steel, galvannealed steel, galvalume steel, tin-coated steel, zinc-coated steel, low carbon micro-alloyed high-strength steel and stainless steel. Preferably, the first metal skin and the second metal skin have the same or different thickness and the thickness is in the range of from about 0.005 inches to about 0.030 inches.

In a preferred embodiment of the present laminate panel, one or both of the first metal layer and the second metal layer comprise steel which has been pretreated with a conversion coating to promote bond integrity and corrosion resistance. In a further preferred embodiment of the present laminate panel, the core layer comprises a flame retardant material.

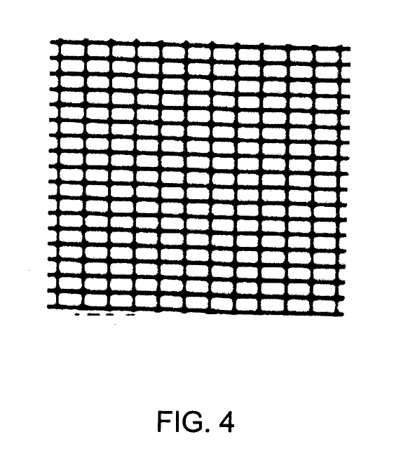

With reference to FIG. 4, there is illustrated an exploded view of a preferred embodiment of porous layer 16 (FIGS. 1 and 2) and 36,40 (FIG. 3).

As can be seen, the porous layer in FIG. 4 comprises a grid-like arrangement of natural fibers, plastic, metal and the like. The porosity of the porous layer refers to the porosity of the entire layer and not to any particular fiber from which the layer is made. Thus, with reference to FIG. 4, the porosity (as defined above) of the porous layer would be determined by calculating the aggregate surface area of the openings in the porous layer and converting this to a percentage of the total surface area of the sample.

Preferably, the compression step in the present process is conducted at a temperature sufficient to soften or melt the thermoplastic resin. Practically, the compression step is conducted at a temperature of at least about 150° C., more preferably in the range of from about 175° C. to about 250° C., most preferably from about 200° C. to about 250° C.

Preferably, the compression step in the present process is conducted at a pressure of at least about 50 psi, more preferably in the range of from about 75 psi to about 600 psi, most preferably in the range of from about 100 to about 400 psi.

Preferably the compression step in the present process is conduct for a period of less than 5 minutes, more preferably less than 2 minutes, most preferably in the range of from about 5 seconds to about 60 seconds.

The foregoing compression step may be conducted in a die press or other suitable equipment.

Those of skill in the art will recognize that the present process can be conducted in a batch press or using continuous laminate equipment (in the latter embodiment it is preferred, in some cases, to pre-apply the thermoplastic resin on the porous layer prior to production of the laminate panel).

Embodiments of the present invention will be described with reference to the following Examples which are for illustrative purposes only and should not be used to construe or otherwise limit the scope of the invention.

### EXAMPLES

In the Examples a number of samples were made using steel skins and a core.

Each steel skin had a thickness of 0.010 inches and a zinc coating (˜60 g/m²) on each side.

The core was either resin alone or a combination of resin and a reinforcing layer.

The resin was a thermoplastic co polyester based elastomer, where the co polyester is a polyether-ester formulation. The resin was used in sheet form. The thickness used in each sample is reported Table 1.

The reinforcing layers used in the samples were: steel woven mesh, woven jute of different weave types, paper, cotton and linen.

Various combinations of pressure, temperature and cycle times were investigated.

The samples were made on a Carver press (75t) at 450° F., for 1 min with a pressure of 10 tons (about 138 psi, except for the resin only samples); followed by a cool in the press, under pressure to 350° F., cooled at about 1.5 s. ° F.⁻¹.

The samples produced are summarized in Table 1.

TABLE 1

| | | Pressure | Thickness |
|---|---|---|---|
| Sample | Reinforcing Layer | (psi) | (in.) |
| 1 | 32 mil resin only | 48 | 0.036 |
| 2 | 30 mil resin only | Very low | 0.05 |
| | | pressure | |
| 3 | (16 mil resin × 2) + 6 oz burlap | 138 | 0.04 |
| 4 | (8 mil resin × 2) + 6 oz burlap | 138 | 0.043 |
| 5 | (10 mil resin × 2) + 6 oz burlap | 138 | 0.047 |
| 6 | (16 mil resin × 2) + steel wire | 138 | 0.047 |
| 7 | (8 mil resin × 2) + cotton | 138 | 0.037 |
| 8 | (8 mil resin × 2) + linen | 138 | 0.037 |
| 9 | (8 mil resin × 2) + paper | 138 | 0.036 |

Samples 1, 2 and 9 are provided for comparative purposes only and thus, these Samples are outside the scope of the invention.

Adhesion was assessed through a T-peel test (ASTM D1876-01). The size of the samples used for this test was 1 in. or 2 in. width and 12 in. length.

Stiffness was determined by a 3-point bend test (ASTM D790-02). Samples of 2 in. width and 10 in. length were tested. An important parameter to consider is the ratio of span to thickness as this will affect the reliability of any modulus predictions (recommended>40:1).

Impact performance was compared by a drop ball type impact tester. The impact results are useful for relative or comparative purposes. The test is similar to that done for plastics-Gardner impact ASTM D5420-98a.

The impact test involved the use of a 4 lb weight at different heights; the maximum height was equivalent to 18 J of energy transferred (indenter diameter of 0.625 in.). The energy reported is the maximum energy at which no cracking was observed. A strip of 2 in. by 10 in. was used for a series of indents.

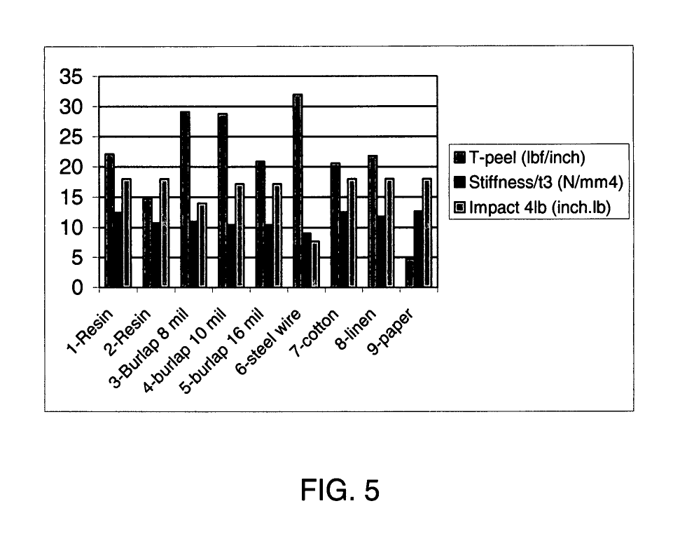

The results for adhesion (T-peel) are reported in lbf/inch, the results for stiffness/t³ are in N/mm4. Two impact tests were performed the first with an indenter of 4 lb, results for this are given in J. The results are shown graphically in FIG. 5.

As shown in FIG. 5, Samples 1 and 2 (resin only core) had a reference adhesion (T-peel), stiffness and impact resistance. Use of paper in the core—i.e., Sample 9 (resin/paper core)—resulted in a significant drop in adhesion (T-peel) compared to that seen for Samples 1 and 2.

In contrast, the use of burlap in the core—i.e., burlap-reinforced Samples 3-5—resulted in a desirable combination of adhesion, stiffness and impact resistance. In particular, and to our surprise, the use of burlap in the core resulted in a significant increase in adhesion (T-peel) as compared to Samples 1 and 2 (resin only core) and to Sample 9 (resin/paper core). In addition, the use of a porous layer (e.g., burlap, cotton, linen, etc.—particularly burlap) in the core resulted in a highly desirable combination of ease of manufacture, product control (dimension, sample integrity, etc.) and cost as compared to Samples 1 and 2 (resin only core) and to Sample 9 (resin/paper core).

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. For example, it is possible to utilize as the thermoplastic resin a laminate of an adhesive layer and a resin layer, for example a co-extruded laminate product of such layers. Alternatively, it is possible to utilize a thermoplastic resin to which has been added an adhesion promoter material. It is therefore comtemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A laminate panel comprising:
a core layer disposed between and bonded to each of a first metal layer and a second metal layer,
the core layer comprising a porous layer substantially encapsulated by a thermoplastic resin.

2. The laminate panel defined in claim 1, wherein the porous layer comprises a porosity of at least about 10%.

3. The laminate panel defined in claim 1, wherein the porous layer comprises a porosity of in the range of from about 10% to about 90%.

4. The laminate panel defined in claim 1, wherein the porous layer comprises a porosity of in the range of from about 20% to about 80%.

5. The laminate panel defined in claim 1, wherein the porous layer comprises a porosity of in the range of from about 30% to about 70%.

6. The laminate panel defined in claim 1, wherein the porous layer comprises a porosity of in the range of from about 35% to about 65%.

7. The laminate panel defined in any one of claims 1-6, wherein the porous layer is fibrous.

8. The laminate panel defined in any one of claims 1-6, wherein the porous layer is non-fibrous.

9. The laminate panel defined in any one of claims 1-8, wherein porous layer is non-metal.

10. The laminate panel defined in any one of claims 1-8, wherein porous layer comprises a metal.

11. The laminate panel defined in any one of claims 1-10, wherein the thermoplastic resin comprises polyethylene.

12. The laminate panel defined in any one of claims 1-10, wherein the thermoplastic resin comprises polypropylene.

13. The laminate panel defined in any one of claims 1-10, wherein the thermoplastic resin comprises a polyolefin.

14. The laminate panel defined in any one of claims 1-10, wherein the thermoplastic resin comprises a copolyester elastomer.

15. The laminate panel defined in any one of claims 1-14, wherein the core layer comprises a single porous layer.

16. The laminate panel defined in any one of claims 1-14, wherein the core layer comprises a plurality of porous layers adhered to one another.

17. The laminate panel defined in claim 16, wherein the core layer comprises a laminate of alternating layers and core adhesive layers, the first adhesive layer and the second adhesive layer being disposed on substantially opposed surfaces of the core layer.

18. The laminate panel defined in claim 17, wherein the first and second adhesive layers comprise a thermoplastic resin.

19. The laminate panel defined in any one of claims 1-18, wherein the porous layer comprises natural fibers.

20. The laminate panel defined in any one of claims 1-18, wherein the porous layer comprises burlap.

21. The laminate panel defined in any one of claims 1-18, wherein the porous layer comprises hemp.

22. The laminate panel defined in any one of claims 1-18, wherein the porous layer comprises woven fibers.

23. The laminate panel defined in any one of claims 1-18, wherein the porous layer comprises woven jute.

24. The laminate panel defined in any one of claims 1-18, wherein the first metal layer and the second metal layer are same.

25. The laminate panel defined in any one of claims 1-24, wherein the first metal layer and the second metal layer are different.

26. The laminate panel defined in any one of claims 1-24, wherein the first metal layer and the second metal layer are the same or different and each is selected from the group consisting of aluminum, titanium, magnesium, cold rolled steel, galvanized steel, galvannealed steel, galvalume steel, tin-coated steel, zinc-coated steel, low carbon micro-alloyed high-strength steel and stainless steel.

27. The laminate panel defined in any one of claims 1-26 wherein the first metal skin and the second metal skin have the same or a different thickness in the range of from about 0.005 inches to about 0.030 inches.

28. The laminate panel defined in any one of claims 1-27, wherein the porous layer has a thickness of at least about 0.01 inches.

29. The laminate panel defined in any one of claims 1-27, wherein the porous layer has a thickness in the range of from about 0.01 inches and 0.25 inches.

30. The laminate panel defined in any one of claims 1-29, wherein the laminate is non-planar.

31. The laminate panel defined in any one of claims 1-29, wherein the laminate is planar and the core layer is planar or non-planar.

32. The laminate panel defined in any one of claims 1-31, wherein one or both of the first metal skin and the second metal skin comprise steel which has been pretreated with a conversion coating to promote bond integrity and corrosion resistance.

33. The laminate panel defined in any one of claims 1-32, wherein the core layer comprises a flame retardant material.

34. A vehicular panel comprising the laminate panel defined in any one of claims 1-33.

35. A process for producing a laminate panel comprising the steps of:
disposing a core layer between a first metal layer and a second metal layer to define an interim laminate, the core layer comprising a first adhesive layer on a surface of a porous layer, the first adhesive layer comprising a thermoplastic material; and
subjecting the interim laminate to a compression step at a temperature of at least about 150° C. and pressure sufficient to cause the first adhesive layer to substantially encapsulated the porous layer, to produce the laminate panel.

36. The process defined in claim 35, wherein the core layer comprise the first adhesive layer and a second adhesive layer on substantially opposed surfaces of the porous layer, the second adhesive layer comprising a thermoplastic material.

37. The process defined in any one of claims 35-36, wherein the compression step is conducted at a temperature in the range of from about 175° C. to about 275° C.

38. The process defined in any one of claims 35-36, wherein the compression step is conducted at a temperature in the range of from about 200° C. to about 250° C.

39. The process defined in any one of claims 36-38, wherein the core layer comprises a laminate of alternating porous layers and core adhesive layers, the first adhesive layer and the second adhesive layer being disposed on substantially opposed surfaces of the core layer.

40. The process defined in claim 39, wherein the core adhesive layers comprise a thermoplastic resin.

41. The process defined in any one of claims 36-40, wherein the first adhesive layer and the second adhesive layer each comprise the same thermoplastic resin.

42. The process defined in any one of claims 36-40, wherein the first adhesive layer and the second adhesive layer comprise a different thermoplastic resin.

43. The process defined in any one of claims 35-42, wherein the thermoplastic material comprises a polyethylene resin.

44. The process defined in any one of claims 35-42, wherein the thermoplastic material comprises a polyolefin resin (e.g., polypropylene resin).

45. The process defined in any one of claims 35-42, wherein the thermoplastic material comprises a copolyester elastomer.

46. The process defined in any one of claims 35-45 wherein the first metal layer and the second metal layer are same.

47. The process defined in any one of claims 35-45, wherein the first metal layer and the second metal layer are different.

48. The process defined in any one of claims 35-45, wherein the first metal layer and the second metal layer are the same or different and each is selected from the group consisting of aluminum, titanium, magnesium, cold rolled steel, galvanized steel, galvannealed steel, galvalume steel, tin-coated steel, zinc-coated steel, low carbon micro-alloyed high-strength steel and stainless steel.

49. The process defined in any one of claims 35-48, wherein the first metal skin and the second metal skin have the same or a different thickness in the range of from about 0.005 inches to about 0.030 inches.

50. The process defined in any one of claims 35-49, wherein the porous layer has a thickness of at least about 0.01 inches.

51. The process defined in any one of claims 35-49, wherein the porous layer has a thickness in the range of from about 0.01 inches and 0.25 inches.

52. The process defined in any one of claims 35-51, wherein the laminate is non-planar.

53. The process defined in any one of claims 35-51, wherein the laminate is planar.

54. The process defined in any one of claims 35-51, wherein one or both of the first metal skin and the second metal skin comprise steel which has been pretreated with a conversion coating to promote bond integrity and corrosion resistance.

55. The process defined in any one of claims 35-54, wherein the porous layer comprises a flame retardant material.

56. The process defined in any one of claims 35-55, wherein the porous layer is fibrous.

57. The process defined in any one of claims 35-55, wherein the porous layer is non-fibrous.

58. The process defined in any one of claims 35-57, wherein porous layer is non-metal.

59. The process defined in any one of claims 35-57, wherein porous layer comprises a metal.

60. The process defined in any one of claims 35-55, wherein the porous layer comprises natural fibers.

61. The process defined in any one of claims 35-55, wherein the porous layer comprises burlap.

62. The process defined in any one of claims 35-55, wherein the porous layer comprises hemp.

63. The process defined in any one of claims 35-55, wherein the porous layer comprises woven fibers

64. The process defined in any one of claims 35-55, wherein the porous layer comprises woven jute.

65. The process defined in any one of claims 35-64, wherein the core layer is planar.

66. The process defined in any one of claims 35-64, wherein the core layer is non-planar.

67. The process defined in any one of claims 35-64, comprising the further step of forming the laminate in a non-planar configuration.
